(19) United States
(12) Patent Application Publication
(10) Pub. No.: US 2018/0189738 A1
(43) Pub. Date: Jul. 5, 2018

(54) In-Place Supervisory Review For Electronic Communications

(71) Applicant: Microsoft Technology Licensing, LLC, Redmond, WA (US)

(72) Inventors: Sanjay Ramaswamy, Redmond, WA (US); Kamal Anupama Janardhan, Redmond, WA (US); Daran Cai, Redmond, WA (US); Julian A. Zbogar-Smith, Bellevue, WA (US); Nakul Garg, Sammamish, WA (US); Samuel J. Shelton, Kirkland, WA (US); Daniel J. Popper, Seattle, WA (US); Gaurav Batra, Redmond, WA (US); Subhayan Sen, Lynnwood, WA (US); Jinhao Li, Redmond, WA (US); Kannan Dhanasekaran, Redmond, WA (US); Xiaocheng Teng, Suzhou (CN)

(21) Appl. No.: 15/460,136

(22) Filed: Mar. 15, 2017

Related U.S. Application Data
(60) Provisional application No. 62/441,067, filed on Dec. 30, 2016.

(51) Int. Cl. G06Q 10/10

(52) U.S. Cl. CPC G06Q 10/107; H04L 63/02

(57) ABSTRACT

Representative embodiments disclose mechanisms to route electronic communications for supervisory review. Users of a messaging system are assigned appropriate permissions to create and manage supervisory review policies, access supervisory review mailboxes to perform supervisory review actions, run reports and other activities associated with supervisory review. Supervisory review policies are pushed out to a supervisory review agent through a policy sync service and the supervisory review agent tests incoming and outgoing messages against the policy. Each policy selects electronic communications and routes the communication to an associated supervisory review mailbox or folder. Additional assistants can receive other electronic communications (social media, chat, voicemail, etc.) and route them to the supervisory review mailbox if the communication meets one or more policies.

### PRIORITY CLAIM

This application claims the benefit of prior filed U.S. Provisional Patent Application No. 62/441,067 entitled “In-Place Supervisory Review for Electronic Communications,” filed 30 Dec. 2016.

### FIELD

This application relates generally to electronic communication systems. More specifically, embodiments disclosed herein include electronic communication systems that provide for in-place supervisory review of electronic communications from disparate types of systems.

### BACKGROUND

Supervisory Review (or Supervision) is a compliance requirement for organizations that are regulated by government bodies such as the Security Exchange Commission (SEC), Financial Industry Regulatory Authority (FINRA), and other such bodies. Even in non-regulated scenarios, Supervisory Review is used to monitor electronic communications. Supervisory Review (SR) involves monitoring of electronic communications between select users, triaging of such electronic communications, and proving to the regulators that SR practices are indeed active and performed at the organization. Not doing so exposes significant risk and fines to such organizations. In non-regulated scenarios, SR can monitor communications for other purposes, such as disclosure of corporate or other information in violation of employment agreements, violation of federal or local laws, and so forth.

Typical SR solutions in the marketplace rely on content being siphoned out of the main messaging or communications platform into a separate archiving system, whereupon the Supervision solution acts as an add-on. In some cases, the Supervision solution vendor is different from the archiving vendor, introducing additional complexities with regards to individual capabilities, compatibility and integration challenges and version control. User interface differences between the two also brings in more friction, as users will need to be trained to work with these disparate products.

It is within this context that the present embodiments arise.

### BRIEF DESCRIPTION OF DRAWINGS

FIG. 1 illustrates an example messaging system architecture according to aspects of the disclosure.

FIG. 2 illustrates another example messaging system architecture according to aspects of the disclosure.

FIG. 3 illustrates another example messaging system architecture according to aspects of the disclosure.

FIG. 4 illustrates another example messaging system architecture according to aspects of the disclosure.

FIG. 5 illustrates an example user interface for assigning permissions for supervisory review.

FIG. 6 illustrates an example user interface for creating policies for supervisory review.

FIG. 7 illustrates an example user interface for creating reports for supervisory review.

FIG. 8 illustrates a representative machine architecture suitable for implementing the systems and other aspects disclosed herein or for executing the methods disclosed herein.

### DETAILED DESCRIPTION

The description that follows includes illustrative systems, methods, user interfaces, techniques, instruction sequences, and computing machine program products that exemplify illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

### Overview

Current messaging systems have little or no support for Supervisory Review (SR) and rely on external SR solutions. Supervisory review is typically coupled to a primary messaging system, such as email, where most of the communications relevant to SR originate or terminate. In an external SR solution, a copy of messages are sent outside the primary messaging system to a separate SR system. A user wishing to perform SR, then logs into the SR system and performs the SR work.

Embodiments of the present disclosure do not utilize a separate SR system. This eliminates complexity on the part of the user and allows SR from within the primary messaging system. No external copies are made of any content. Instead, SR of electronic communications is provided in-place, with data continuing to reside where it is. Users needn't have to worry about multiple solutions and learning new skills, since standard messaging system experiences expose the SR capabilities. The primary messaging system is also able to monitor not just email communications, but also other communication modalities such as social, IM, and specialized mediums that are unique to industry verticals. Well-known email triaging experiences in clients can also be used to also triage supervised communications in some embodiments, without the need for specialized applications or add-ins. Finally, built-in reporting capabilities generate reports as needed by organizations to document as evidence of supervision practices within the organization.

### Description

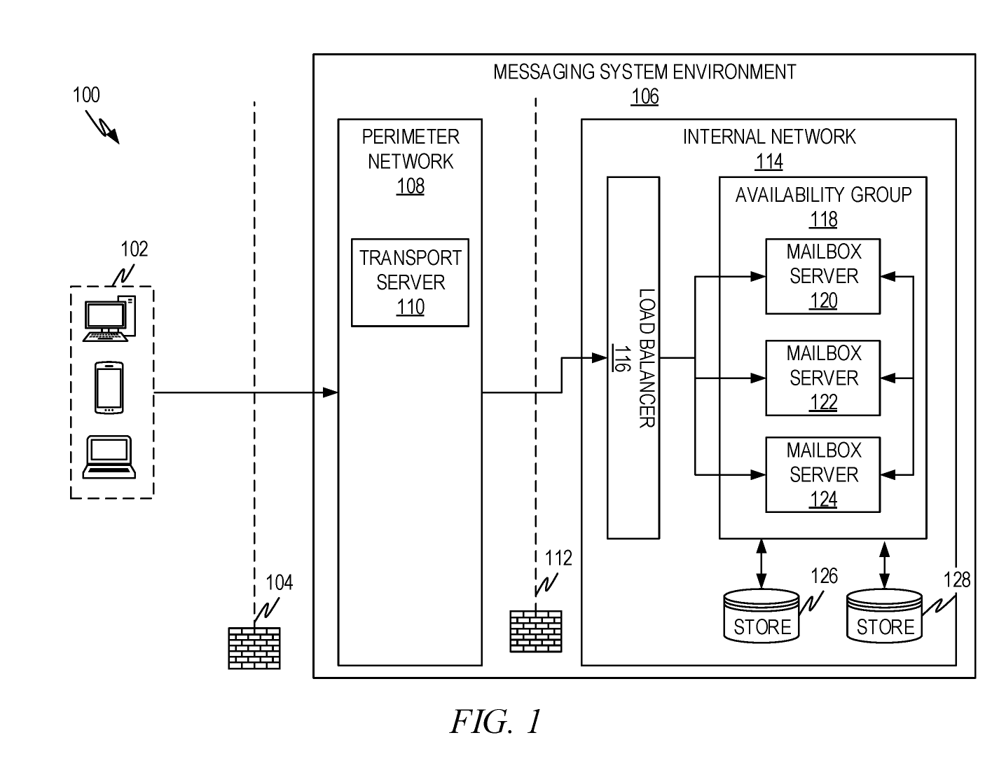

FIG. 1 illustrates an example messaging system architecture according to aspects of the disclosure. The example architecture comprises several aspects that may not exist in all embodiments. Furthermore, alternative architectures are also available that will work with the disclosed embodiments.

A representative architecture may comprise one or more mailbox servers 120, 122, 124. Mailbox servers contain transport services that are used to route mail and a representative mailbox server is illustrated in greater detail below. Mailbox servers also may comprise databases that process, render and store data, such as email and other electronic communications and related data. Mailbox servers may also comprise client access services that accept client connections for various protocols. These frontend services are responsible for routing or proxying connections to the corresponding backend services on a mailbox server. In these embodiments, clients do not connect directly to the backend services. Mailbox servers can also comprise unified messaging services that provide voice mail, telephony and other features to a mailbox. Additionally, messaging services can provide access to other electronic communications as described below. Mailbox servers are managed through an admin center, a management shell, or other such mechanisms.

Mailbox servers may be collected into an availability group 118 in order to provide high availability. An availability group can host a set of databases 126, 128 and provide automatic, database-level recovery from database, network and server failures. Thus, user and other mailboxes described herein can be hosted in such a way that failure of a mailbox server, database, network and so forth will not impact the ability of the user to access the appropriate electronic communications.

A load balancer 116 can balance loads between mailbox servers 120, 122 124 of an availability group 118. Load balancers are well known and need not be described in greater detail here.

In large installations with redundant servers, availability groups and so forth, additional transport server(s) 110 can be added, such as in a perimeter network 108. The transport server 110 can handle external mail flow for the organization (e.g., internal network 114). A synchronization service (not shown) can make recipient and other configuration information (such as supervisory review policy information) available to the transport server 110 as mail enters and leaves the organization. The transport server can also comprise mail flow rules, antispam filtering, and a supervisory agent as described in greater detail below. The transport server 110 can be managed through a management shell, admin center, and so forth.

The messaging system environment 106 can also comprise firewalls, such as 112 and 104, to provide enhanced security to the organization. Users can interact with the messaging system through clients, web browsers, and other such programs through various devices 102.

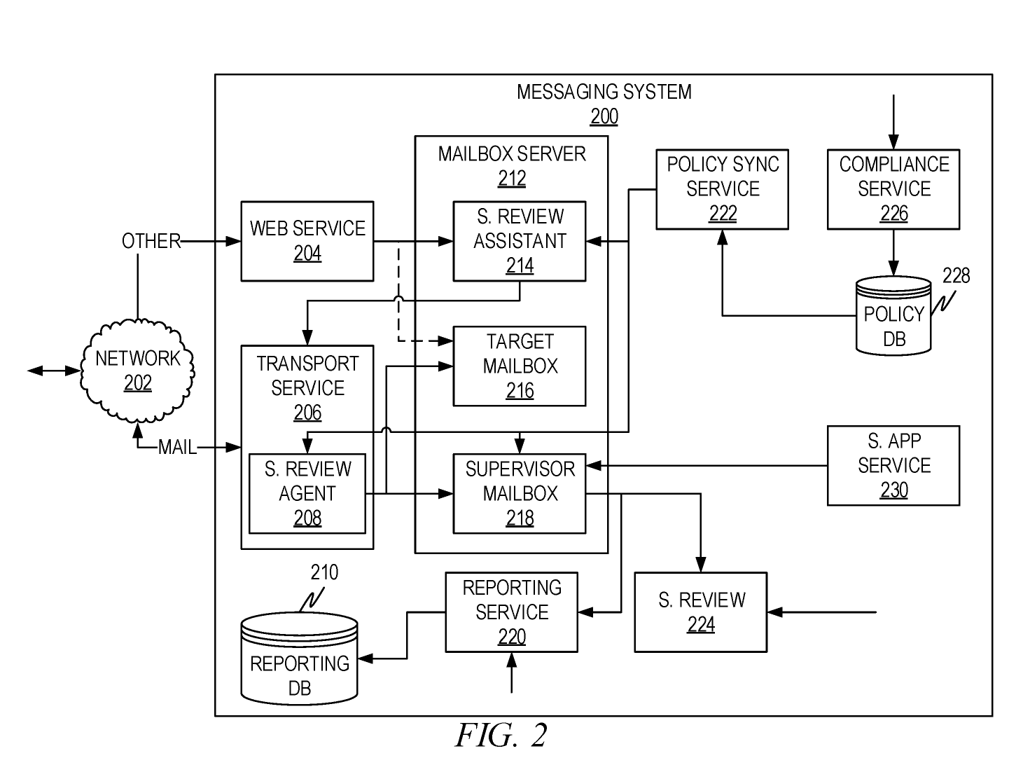

FIG. 2 illustrates another example messaging system architecture 200 according to aspects of the disclosure. The messaging system 200 provides supervisory review functionality that eliminates the necessity of a separate supervisory review system.

### Administrative Aspects

To set up SR aspects of the system, an administrator or other authored user can set up permissions that allow a user to perform SR functions. This can be performed, for example, by assigning one or more users to a SR role or SR group and/or by assigning permissions to one or more users. For example, a user can be given the permission to be a SR administrator, which allows the user to administer other users in the SR role, such as by assigning various SR permissions or roles to a user. Other permissions that can be granted are permissions to create SR policies, to access electronic communications selected by the SR policies for SR review (i.e., access a mailbox, folder, and so forth); to perform SR of electronic communications (i.e., mark communications as compliant, non-compliant and active, non-compliant and pending resolution, and so forth), to run SR reports, and so forth.

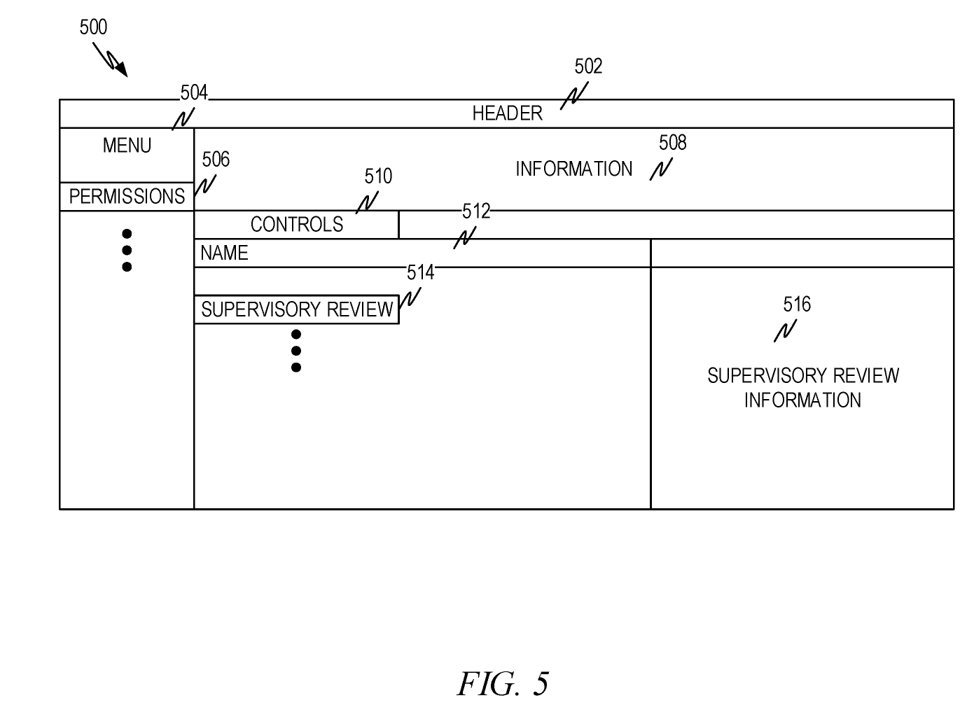

Turning for a moment to FIG. 5 a representative user interface 500 is illustrated to allow an administrator, SR administrator or other authorized user to convey permissions and/or roles to users to perform SR functions.

The user interface 500 can comprise a header area 502 that contains information and/or controls for the user to perform general functions. For example, the header can tell the user the name of the messaging system, have a control that allows a user to examine their profile and/or account, logon, logoff, bring up system settings, get help and so forth.

The user interface 500 can also comprise a menu area 504 that comprises one or more menu items, one of which can be to set permissions 506. Selection of the permissions item 506 sets the remaining areas (508-516) to the content, controls, and so forth for assigning permissions. For example, information area 508 can comprise information to allow the user to identify what the permissions menu item provides. In a representative example, the information can tell the user that the permissions menu item allows them to assign permissions to users so they can perform functions in the compliance area.

The controls area 510 contains controls that allow the user to actually perform the permission assignment such as add permissions to a user, edit permissions of a user, copy permissions and other such functionality.

The name area 512 is a label that heads the list underneath. The list comprises the permissions that can be assigned, edited, and so forth. One entry on the list can be the supervisory review item 514. When this item is selected, the information area 516 can display the tasks that can be performed, the specific permissions associated with the item that can be assigned, edited, and so forth.

Using the interface illustrated in FIG. 5, an administrator would select the supervisory review item 514 and then select a control 510 such as add permissions to a user, edit permissions of a user and so forth. A popup, dialog, or other user interface can be presented that allows the administrator to identify the user(s) and the permission(s) that are to be assigned to the user.

Through the user interface 500 and related interfaces, the administrator authorizes users to perform SR functions.

### Policies

Returning now to FIG. 2, SR policies will now be described. SR involves monitoring of electronic communications between select users, triaging of such electronic communications, and proving to the regulators that SR practices are indeed active and performed at the organization. An SR policy define the users and electronic communications that are to be triaged in a SR. An SR policy comprises one or more rules which select electronic communications for SR. Each rule in the policy can comprise a combination of conditions, exceptions, actions and properties.

Conditions specify the characteristics of messages to which the SR policy applies. Conditions can examine electronic communication fields, such as the TO, FROM or CC fields. Other conditions can examine message characteristics such as the subject line, the body, attachments, message size, message classification and so forth. Still other conditions can examine the envelope or other metadata associated with the message such as the domain from which a message originates/terminates, the sender/receiver is a member of a particular group, and so forth. Conditions can look for words, phrases, and/or other patterns in any field, metadata, characteristic, text body, etc. of a message. Thus, conditions can select out messages that have particular information/patterns in the body of the communications. Conditions can also identify the types of electronic communications that the policy applies to such as email, chat, post, etc. Conditions can be created for any combination of fields, metadata, characteristics, message data, and so forth of the communication. Most conditions can comprise one or more operators such as equals, doesn't equal, contains, a value to match and so forth. Regularized expressions can also be utilized for patterns, and so forth.

Exceptions are based on the same set of characteristics used to build conditions. However, unlike conditions, exceptions identify messages to which the SR policy should not be applied. Exceptions override conditions and prevent actions from being applied to a particular communication, even if the condition applies.

Actions are applied to communications that match the conditions and that do not match the exceptions. Actions can include sending the communication to an SR mailbox, adding prefixes/postfixes to fields, inserting information into the message body, adding notifications/additional recipients, and so forth. Embodiments can include a default action (i.e., an action automatically associated with an SR policy and that may not be changed by the user). In a representative embodiment, messages that match the conditions and that do not match the exceptions are sent to an SR mailbox associated with the SR policy as explained in the mailbox and storage discussion below. Thus, in some embodiments, the user is unable to define actions that are taken when communications match the SR conditions and do not match the SR exceptions.

Properties specify when and how the SR policy should be applied, including whether to enforce or test the policy and the time period to which the policy applies. As representative examples, properties can be used to:
Control which rules (all or a subset) are performed;
Include/exclude particular types of rules (e.g., rules that impact mail delivery, notification and so forth);
Identify the order in which rules are processed if multiple rules exist;
Set the time/date to start and stop the policy;
Enable/disable rule(s);
Identify what to do if processing fails;
Identify how to evaluate the sender address (i.e., match the value in the header, in the message envelope, or both);
Identify the communication type(s) (email, web posting, chat thread, etc.) that the policy applies to; and
Combinations thereof.

Users with appropriate permissions can create SR policies through a service, such as compliance service 226. Compliance service 226 can present one or more user interfaces to the user that allow the user to create one or more SR policies.

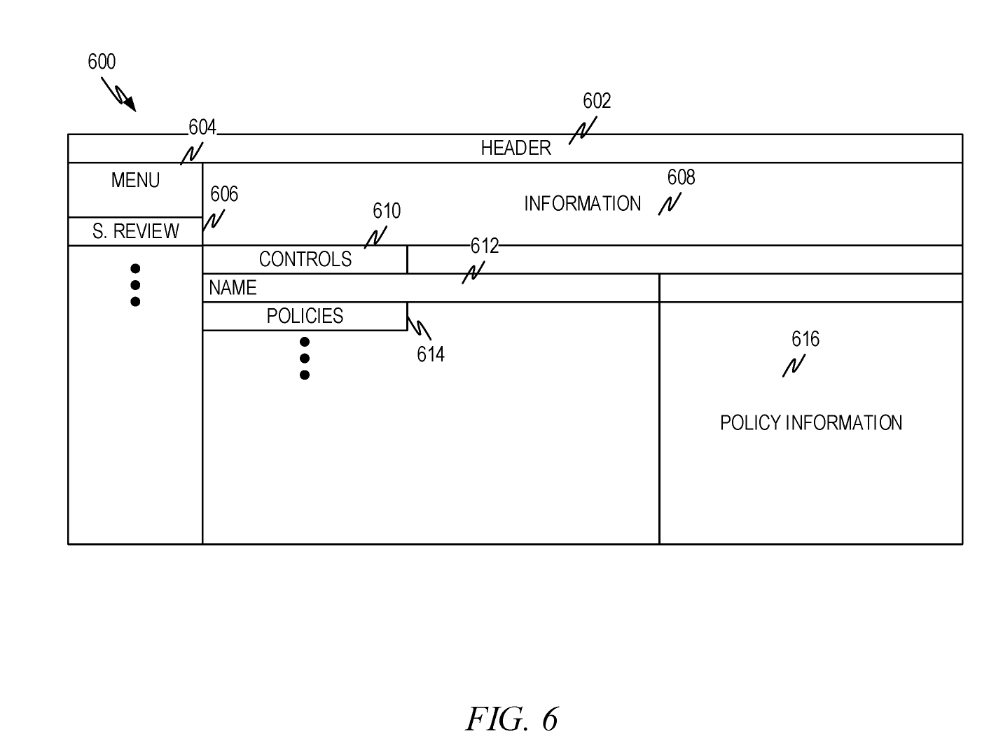

Turning for a moment to FIG. 6, a representative UI 600 for SR policy creation is illustrated. The user interface 600 can comprise a header area 602 that contains information and/or controls for the user to perform general functions. For example, the header can tell the user the name of the messaging system, have a control that allows a user to examine their profile and/or account, logon, logoff, bring up system settings, get help and so forth.

The user interface 600 can also comprise a menu area 604 that comprises one or more menu items, one of which can be to create supervisory review policies 606. Selection of the supervisory review item 506 sets the remaining areas (608-616) to the content, controls, and so forth for creating SR policies. For example, information area 608 can comprise information to allow the user to identify what the supervisory review menu item provides. In a representative example, the information can tell the user that the supervisory review menu item allows the user to define policies that select electronic communications for SR.

The controls area 610 contains controls that allow the user to actually perform the SR policy work such as add a policy, edit a policy, copy a policy and other such functionality.

The name area 612 is a label that heads the list underneath. The list comprises the various policies 614 that have been crated. When a particular policy is selected, the information area 616 can display details related to the policy.

When creating a policy through the UI of FIG. 6, a user would select a control (create, edit, copy, etc.). A popup, dialog, or other user interface can be presented that allows the user to create rules associated with the policy and define the conditions, exceptions, actions and properties associated with each rule.

Returning now to FIG. 2, once a policy is created through compliance service 226, the policy can be stored in a data store such as policy database 228.

For policies to be effectuated, they are made available to the various components via a policy sync service 222. The policy sync service 222 performs several functions. Each policy is associated with a particular SR mailbox and/or folder within a particular SR mailbox. In some embodiments, each policy is associated with a particular folder in the SR mailbox. In these embodiments, all communications selected for SR in a particular organization will be sent to an associated folder in the SR mailbox. Thus, the organization will have a single SR mailbox and each policy will have its own folder under the SR mailbox. In these embodiments, users may be granted access to a subset of the folders in the SR mailbox (i.e., all folders or less than all folders in the SR mailbox). In other embodiments, a SR policy is associated with a particular SR mailbox and the organization can have multiple SR mailboxes. In these embodiments, all communications selected for SR in an organization will be sent to an SR mailbox associated with the policy that selected the communication. In still other embodiments, a combination can be used so that SR policies can be associated with an SR mailbox or a folder within an SR mailbox. Thus, an SR mailbox can have an associated policy while other policies can be associated with folders within the different SR mailboxes. In any of the described embodiments, users can be granted access to a subset of the SR mailboxes and/or folders within the SR mailbox. Access would be granted as described above in conjunction with the permissions. Thus, one function performed by the policy sync service 222 is to create and/or configure the SR mailbox and/or folder within the SR mailbox so that the SR policy is associated with the appropriate SR mailbox and/or folder. This is illustrated in FIG. 2 by the arrow running from the policy sync service 222 to the SR mailbox 218.

The policy sync service 222 also ensures the rules of the SR policy are made available to the SR agent 208 and the SR assistant 214 as discussed below.

As policies are added, deleted, updated and so forth, the policy sync service 222 ensures that the appropriate changes are made in the system to effectuate the SR policies.

### Routing of Electronic Communications

The routing of electronic communications is accomplished by the SR agent 208 and/or the SR assistant 214 as appropriate. Electronic communications can comprise email as well as other types of electronic communications, such as social media posts, tweets, chats, voice mail, and other types of electronic communications. The description below first covers email and then covers other types of electronic communications.

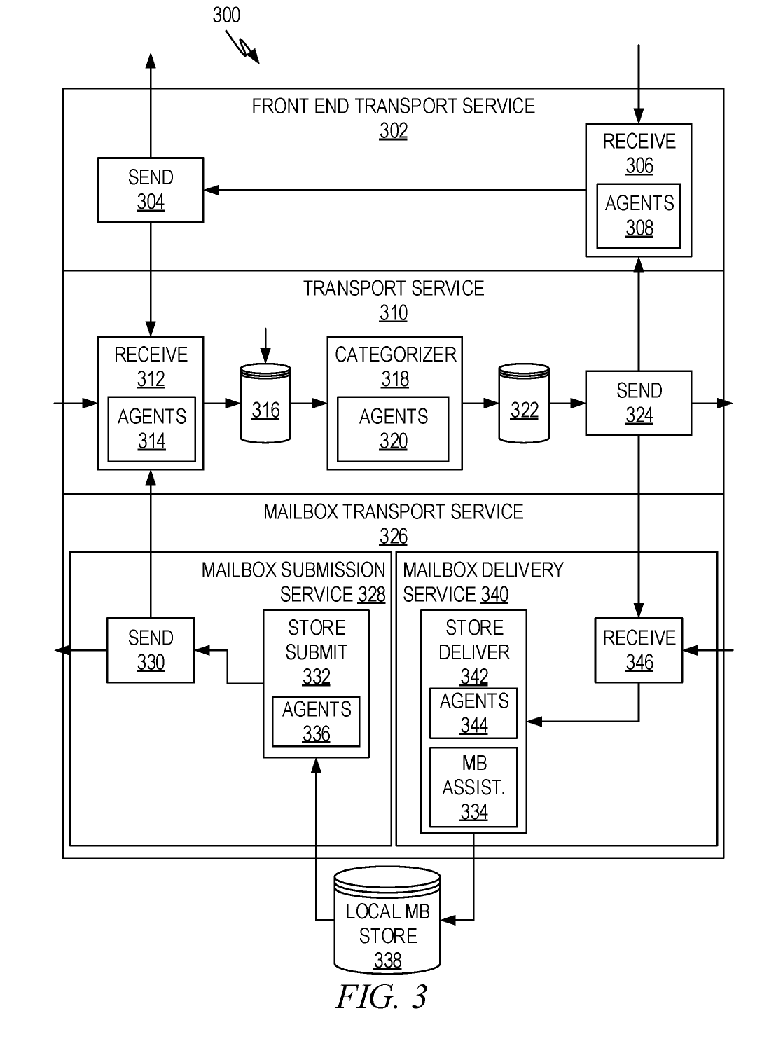

Incoming email typically arrives over a network 202 as indicated by the corresponding arrow. Incoming email is routed within the messaging system 200 by one or more transport services 206. As discussed in embodiments of FIGS. 1, 3 and 4, messaging systems 200 can comprise numerous transport services. Depending on the size and scale of the installation, one or more of the transport services 206 comprises a SR agent 208. The SR agent 208 is placed in a transport service 206 in order to allow processing of incoming and outgoing email communications. As explained below, there can be several suitable transport services that can be used, for example, in some embodiments, the SR agent 208 may be placed in transport server 110 of FIG. 1. For embodiments that do not utilize a transport server 110, the SR agent 208 can be part of a transport service in a mailbox server (i.e., mailbox server 212 or the mailbox servers shown FIGS. 1, 3 and/or 4).

The SR agent 208 implements the rules of the SR policies and takes the appropriate action(s) specified in the SR policies. In a representative example, all incoming and outgoing mail is checked against the SR policies and when the rules of an SR policy are met, a copy of the message is sent to the corresponding SR mailbox 218 and/or corresponding folder within the SR mailbox 218 (hereafter referred to as the SR mailbox/folder 218). In this way, the mail communications subject to SR are captured within the email system. The email is also delivered to the target mailbox 216 (in the case of incoming email) and/or sent to the external recipients (in the case of outgoing email).

Rather than sending copies of the email to the SR mailbox/folder 218, the original email can be delivered to the target mailbox 216 and a link placed in the SR mailbox/folder 218 so that a copy of the email need not be maintained separately. The link can have associated metadata so that the link behaves as if a copy of the email were in the SR mailbox/folder 218. In this embodiment, outgoing mail may still have a copy sent to the SR mailbox/folder 218.

Thus, the mail routing for incoming mail is that the SR agent 208 routes a copy of the mail to the SR mailbox and/or folder associated with any triggered SR policies. A copy of the incoming mail is delivered to the target mailbox 216 as normal with no interruption in the recipient's normal email experience. For outgoing mail, the SR agent 208 routes a copy of the mail to the SR mailbox/folder 218 associated with any triggered SR policies and the mail is also delivered to any recipients as specified in the mail.

The embodiments disclosed herein may also receive other electronic communications that can be the subject of SR policies. By way of example, and not limitation, these other electronic communications can include social media comments, posts, tweets, and so forth, email from other systems, chat type communications, voicemail, and other electronic communications. These other electronic communications can have different formats, protocols, and so forth. Two major approaches with different variations can be taken when collecting these other electronic communications.

As a first major approach, the other electronic communications can be placed into a format and/or protocol that is compatible with the messaging system 200. For example, agents can be added to other electronic communication systems that place the electronic communication in an email and route it to the messaging system. As a representative example, the other electronic communication can be converted and/or placed in a wrapper and the content of the communication can be placed in the body of the email and other metadata describing the communication translated to fields/characteristics of the email message, the envelope, and/or placed in the body. In this instance, the other electronic communication may be processed as previously described, with the exception that a copy may or may not be delivered to the target mailbox 216.

Additionally, or alternatively, the other electronic communication systems can route email and/or other communications through a web service 204. These can be placed in an email wrapper or otherwise converted from the native format/protocol or can be retained in their original protocol and format, depending on the embodiment. For example, if the communication is converted and/or placed in a wrapper, the content of the communication can be placed in the body of the email and other metadata describing the communication translated to fields/characteristics of the email message, the envelope, and/or placed in the body. In this way, when the converted communication is processed, it can be routed to the SR mailbox/folder 218 and, when reviewed, the reviewer can identify the circumstances surrounding the communication.

In one embodiment, the originating communication system comprises an agent, much like SR agent 208. The agent will monitor communications on the originating system and extract items from the electronic communication and place the items in a wrapper, envelope or other format compatible with messaging system 200. For example, if messaging system 200 is an email system, then the electronic communication is placed in an email format with appropriate fields so that the email is routed appropriately and so that the source of the communication can be identified.

In another embodiment, a connector is used to extract data from the originating communication system and convert the extracted data into a format and protocol suitable for sending to the messaging system 200. The connector can be a separate system that is able to communicate both to the originating communication system and to the messaging system 200 as well as perform the appropriate mapping and format/protocol changes.

If the electronic communication retains its native format and/or protocol, the web service can implement the protocol to communicate (i.e., over network 202) with the originating electronic communication system. In such an instance, one of two ways can be used to communicate with the originating communication system to retrieve appropriate communications. In a first embodiment, user credentials can be used to retrieve electronic communications from the originating communication system. Additionally, or alternatively, the originating communication system can have agents, similar to the SR agent 208 that collect communications (i.e., from/to particular users) and send them to the messaging system 200 via web service 204. In this embodiment, the collection agent on the originating communication system monitors the system for communications that are to be forwarded to the messaging system 200. The agent can then extract items from the electronic communication, and, if necessary, changes the format/protocol to be compatible with the messaging system 200. In yet another embodiment, a connector can be used to retrieve information from originating communication systems and forward them to the messaging system 200, as described above.

As electronic communications are received via web service 204, they are routed to the mailbox server 212 where the target mailbox 216 resides. The target mailbox 216 is the mailbox of the user that is one party to the communication. For example, the sender or recipient of a chat, the poster of a comment on social media, and so forth. As explained in greater detail below, the mailbox server 212 can comprise a supervisory review assistant. The supervisory review assistant can re-route the other electronic communications back to supervisory review agent 208 where they can be checked against SR policies. If the other electronic communication meets the SR policy, the SR agent 208 can route the other electronic communication to the appropriate SR mailbox/folder 218. A copy of the other electronic communication can optionally be routed to the target mailbox.

### Supervisory Review Mailbox

Supervisory review mailboxes may be a particular type of mailbox within the messaging system 200. These mailboxes tend to collect large numbers of communications, particularly in embodiments where a single SR mailbox collects communications for an entire organization (i.e., with different SR policies funneling mail into different folders within the SR mailbox as explained above). Thus, in some embodiments, the SR mailbox has an unlimited storage limit. In other embodiments, storage limits can be placed on the SR mailbox by administrators or other authorized individuals. In either case, the SR mailbox can have associated retention policy/policies that define when data is to be retained and when the data can be purged and/or archived. These retention policies are configurable by users with appropriate permissions, which may be the same as or different from permissions that allow users to take other SR actions.

In some embodiments, SR mailboxes have a fine grained permission structure so that permissions can be assigned to users on an as needed basis either for the SR mailbox, folders within the SR mailbox, or any combination thereof. Example permissions comprise:
Read items within an SR mailbox and/or folder within the SR mailbox;
Perform SR actions (i.e., mark communications as reviewed, compliant, questionable, non-compliant (active), non-compliant (resolved), and so forth);
Run SR reports;
Create SR policies;
Edit SR policies;
Review/read SR policies;
Manage SR mailbox and/or folders within the SR mailbox;
Add communications to the SR mailbox; and
Combinations thereof.

Additionally, or alternatively, the SR actions can have fine grained permissions so that a user may be granted the ability to perform some SR actions and not others. The permission structure helps ensure that only authorized individuals are able to see and/or review the communications subject to SR review and take actions in accordance with SR procedures and policies.

Other embodiments can have different levels of permissions so that how fine grained the permissions are can vary from embodiment to embodiment. For example, in embodiments with less fine grained permissions, any member filling an SR role will have access to all administrative tasks such as viewing reports and so forth. Permissions need only be fine grained enough to allow authorized individuals to perform authorized tasks while precluding non-authorized individuals from the same. Thus, how fine grained the permissions are may depend on the goals and requirements of the SR process for both regulated and non-regulated scenarios.

Logging can be enabled for SR mailboxes/folders in order to track which not only which communications enter and/or leave the SR mailbox/folders but also which actions are taken by which individuals and to help prove that SR policies and procedures are followed. Logs are collected for reporting as discussed below.

Items that have been reviewed and marked can be periodically archived or archived based on the occurrence of a particular event or combination of events. For example, if the SR reviews are audited quarterly, those items that pass the audit can be archived once the audit is complete.

### Supervisory Review Actions

When a user with appropriate permissions desires to review communications as part of an SR review, they log into the messaging system 200 through any usual mechanism and open the appropriate SR mailbox/folder 218. This is indicated in FIG. 2 by supervisory review process 224. As noted above, in some embodiments SR policies have a 1:1 relationship with a particular SR mailbox and/or folder so that all mail meeting a particular SR policy will be located in a particular SR mailbox/folder. Since an SR policy can comprise multiple rules, in other embodiments a single SR policy can funnel communications into different SR mailbox and/or folders based on which rules of the policy are satisfied. For example, the Action associated with a rule can identify which SR mailbox/folder the communication is sent to when the rule is satisfied.

Supervisory review typically involves a user reviewing communications and marking the communications in accordance with supervisory review policies and procedures. This means that a user with appropriate permissions reviews the individual communications and tags them with a status that represents the result of the review. Example status can include, but are not limited to:
Not Reviewed: this status indicates the communication has not yet been reviewed. This status can be automatically set as communications are delivered into the SR mailbox/folder. Additionally, or alternatively the SR policy can determine what status should be set upon delivery into the SR mailbox/folder.
Compliant: this status indicates that the communication has been reviewed and has been found to be compliant. No further action is needed.
Questionable: This status acts as a flag for further review. For example, a reviewer might need to check with a supervisory review procedure or might need to send it for further review by another reviewer. The status can also be used when a communication needs further investigation.
Non-Compliant (Active): This status indicates that a communication is non-compliant and that further investigation is ongoing.
Non-Compliant (Resolved): This status indicates that the communication was found non-compliant and that any further investigation has been resolved.

Additionally, the communications in the SR mailbox/folder can have additional metadata associated with them that help in SR review, workflow, auditing and other such activities. For example, embodiments can allow reviewers to add comments to a communication, assign communications to a particular reviewer, and so forth.

As indicated above, logging can be enabled so that the actions of reviewers can be tracked to ensure compliance with SR procedures.

### Audit Logging

Auditing is a part of compliance for SR reviews. Logging for purpose of auditing can comprise logs from multiple locations and can comprise logs of different types. For example, the built in logging capability of the messaging system 200 can be leveraged to capture all SR administrative activity that occurs, for example, through the admin center, management shell, or other such mechanisms. Thus, activities such as granting permissions, creating SR mailboxes/folders, managing SR policies and so forth can be captured by the messaging system 200 logging system.

Additionally, all SR activities can be captured and centrally logged for later auditing/reporting. Thus, a unique identifier can be associated with each communication that is placed in a SR mailbox/folder. This unique identifier is assigned in such a way that the communication can be distinguished from other communications in the messaging system 200. If the messaging system 200 assigns unique identifiers to communications that meet these criteria, the built-in unique identifiers can be used.

The logging system tracks each review activity performed for each communication by each reviewer, providing detail as to what occurred on each message (i.e., the communication state), if a comment was added, whether the message was assigned a different reviewer and so forth. In this way, all activities associated with a message are logged for later auditing. The logged information can comprise any combination of:
Policy name;
Unique message identifier;
Message information/metadata (sender, receiver, message type, and so forth);
Status (i.e., not-reviewed, compliant, questionable, non-compliant (active), non-compliant (resolved), etc.);
Reviewer;
Activity taken (i.e., status set); and
Time/date of the action.

The logging system can forward and/or store the collected logs in the reporting database 210 for later reporting and analysis. In some embodiments, the logs are secured from tampering, such as by appropriate permissions or other security measures. If the messaging system 200 has a built-in reporting infrastructure, that infrastructure can be utilized as long as it meets the SR procedure requirements.

### Reporting

Embodiments of the present disclosure can also comprise a reporting service 220 which allows auditing and reporting of SR activities. Users with appropriate permissions can access the reporting service 220 in order to run various reports, export data for comprehensive offline analysis, and so forth. The reporting service 220 is accessed by a user logging onto the system through any authorized mechanism and accessing the reporting service 220, such as described below.

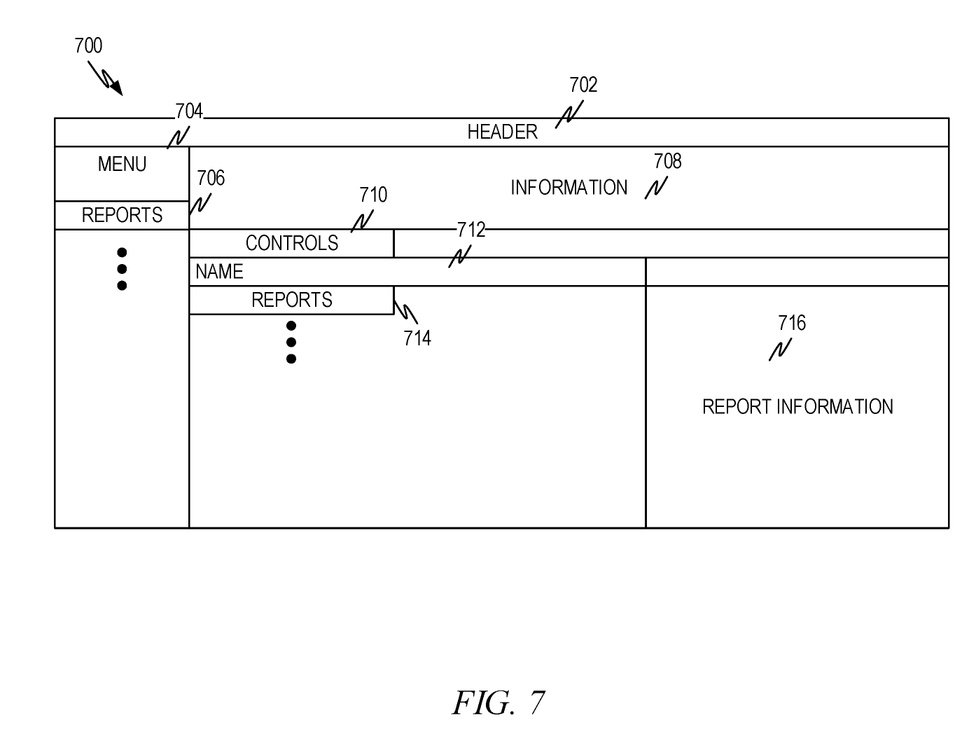

Turning for a moment to FIG. 7, a representative UI is illustrated to show how the reporting module can be accessed. The user interface 700 can comprise a header area 702 that contains information and/or controls for the user to perform general functions. For example, the header can tell the user the name of the messaging system, have a control that allows a user to examine their profile and/or account, logon, logoff, bring up system settings, get help and so forth.

The user interface 700 can also comprise a menu area 704 that comprises one or more menu items, one of which can be to access the reporting service 220. Selection of the reporting item 706 sets the remaining areas (708-716) to the content, controls, and so forth for creating SR reports. For example, information area 708 can comprise information to allow the user to identify what the reporting menu item provides. In a representative example, the information can tell the user that the reporting menu item allows the user to create reports.

The controls area 710 contains controls that allow the user to actually perform the reporting function, for example create a new SR report, run an SR report, and so forth.

The name area 712 is a label that heads the list underneath. The list comprises the reports 714 that have been crated. When a particular report is selected, the information area 716 can display details related to the policy.

The user interface can provide controls and other information to allow an authorized user to:
View the current status of supervisory review policies in an organization;
Download activity reports for further analysis offline;
Select a policy and download reports for that policy;
Create status activity and/or reviewer activity reports as detailed below;
Create other reports based on logged data fields; and
Enter time/date ranges for a report.

When utilizing the reporting service through the UI of FIG. 7, a user would select a control (create, edit, copy, etc.). A popup, dialog, or other user interface can be presented that allows the user to perform the desired functions.

SR reports are visible only to those that have appropriate permissions, such as those that fill an SR role. Reports can be based on a variety of logged fields. Furthermore, reports can be tied to one or more SR policy. Since an RS policy pulls in communications meeting specified criteria, a report can be based on any combination of the logged fields of the communications for one or more SR policies. For example, a policy status and activity report pulls the following information for a given date range:
Policy name;
Message type;
Number of messages targeted for review for the dates of the report;
Sampled messages: Number of the subset of the targeted messages that were sampled during the dates of the report;
Hits: Number of the subset of the sampled messages that met the policy requirements;
Not-Reviewed Items: number of items having a not reviewed status;
Compliant Items: number of items having a compliant status;
Questionable items: number of items having a questionable status;
Non-compliant (active) items: number of items having a non-compliant (active) status;
Non-compliant (resolved) items: number of items having a non-compliant (resolved) status;

As another example, a reviewer activity report pulls the following information for a given date range:
Reviewer;
Policy name;
Message type;
Not-Reviewed Items: number of items having a not reviewed status;
Compliant Items: number of items having a compliant status;
Questionable items: number of items having a questionable status;
Non-compliant (active) items: number of items having a non-compliant (active) status;
Non-compliant (resolved) items: number of items having a non-compliant (resolved) status;

Other reports can pull different fields and summarize different information from the logged data. Any of the fields in the logged data can be the basis of reports in the system.

### Other Embodiments

FIG. 3 illustrates another example messaging system architecture 300 according to aspects of the disclosure. The architecture 300 can represent, for example, a representative mailbox server architecture. The mailbox server architecture can comprise a front end transport service 302, a transport service 310, a mailbox transport service 326, and a local mailbox store 338.

The front end transport service 302 acts as a stateless proxy for all inbound and outbound external communication traffic. The front end transport service doesn't inspect message content and does not queue any messages locally. The front end transport service comprises a send service 304, a receive service 306 that utilize one or more protocols, such as Simple Mail Transfer Protocol (SMTP). The receive service 306 may comprise one or more protocol agents 308 that implement various protcols.

The transport service 310 handles all mail flow for the organization and performs message categorization and message content inspection. The transport service 310 does not communicate directly with mailbox databases (i.e., the local mailbox store 338). The transport service 310 routes messages among the mailbox transport service 326, the front-end transport service 302 and other transport services on other mailbox servers.

The transport service 310 comprises a receive service 312 that can comprise various protocol agents 314. The receive service 312 utilizes a protocol such as SMTP to communicate with other send and/or receive services. The receive service 312 performs message content inspect, applies transport rules, performs anti-spam and anti-malware inspection and so forth. If a message isn't rejected by any of the message inspection that is performed, the message is placed in a submission queue 316. Other message sources can feed into the submission queue 316 such as a pickup directory and/or replay directory. These directories allow properly formatted messages to pass directly into the submission queue.

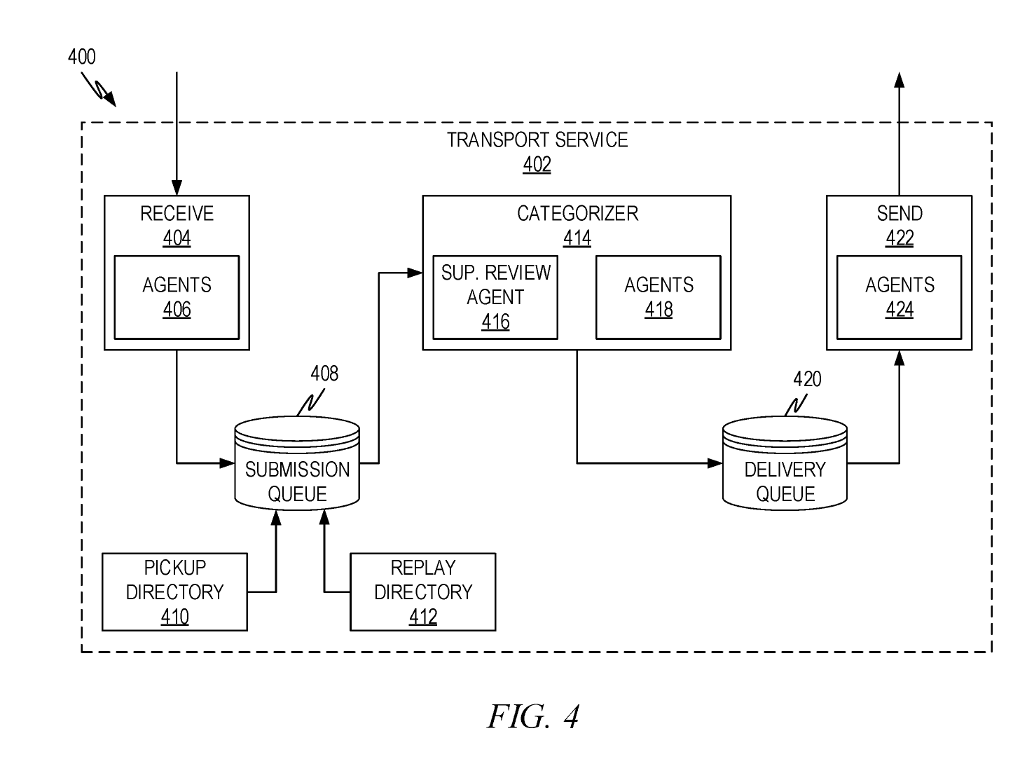

The categorizer 318 picks up messages one at a time from the submission queue and performs various operations such as recipient resolution (top-level addressing, distribution group expansion, message bifurcation, etc.), routing resolution and content conversion. Mail flow rules are also applied in the categorizer. As discussed in FIG. 4, the supervisory review agent can be placed in the categorizer to route messages meeting one or more SR policies to the appropriate SR mailboxes/folders.

After messages have been categorized, they are placed into a delivery queue 322 based on the destination of the message. Messages are queued by the destination mailbox, availability group, and so forth. The send service 324 routes messages to according to the destination. For example, the send service 324 can route messages to the mailbox transport delivery service 340 for mailboxes that are on the same mailbox server or to the mailbox transport delivery service of a different mailbox server that is part of the same availability group. The send service 324 can route to the transport service of a mailbox server in a different availability group, or other grouping. For delivery through the internet, the send service 324 can route to the front end transport service 302, to the transport service on a different mailbox server, or various other ways depending on how the mailbox server is configured and connected to the internet.

The mailbox transport service 326 delivers mail to and sends mail from the local mailbox store 338. The mailbox delivery service 340 comprises a receive service 346 that receives messages, such as by SMTP and passes the mail to the store delivery service 342. The store delivery service 342 ensures that mail is delivered to the appropriate mailbox in the data store. Store delivery service 342 may also comprise a mailbox assistant 334 as discussed above. One function of the mailbox assistant 334 is to ensure that other communications that have not yet been processed by the SR agent get routed to the SR agent for processing. Thus, the assistant can pass communications to the store submit process 332 for delivery to the SR agent.

The mailbox submission service 328 retrieves mail from the local mailbox store 338 and passes it to the send process 330 for eventual delivery to the proper location.

FIG. 4 illustrates another example messaging system architecture 400 according to aspects of the disclosure. This architecture is an expanded view of a representative transport service (i.e., transport service 310) that incorporates an SR agent. The transport service 402 operates as explained above. The transport service 402 handles all mail flow for the organization and performs message categorization and message content inspection. The transport service 402 does not communicate directly with mailbox databases. The transport service 402 routes messages among the mailbox transport service, the front-end transport service and other transport services on other mailbox servers.

The transport service 402 comprises a receive service 404 that can comprise various protocol agents 406. The receive service 404 utilizes a protocol such as SMTP to communicate with other send and/or receive services. The receive service 404 performs message content inspect, applies transport rules, performs anti-spam and anti-malware inspection and so forth. If a message isn't rejected by any of the message inspection that is performed, the message is placed in a submission queue 408. Other message sources can feed into the submission queue 408 such as a pickup directory 410 and/or replay directory 412. These directories allow properly formatted messages to pass directly into the submission queue.

The categorizer 414 picks up messages one at a time from the submission queue and performs various operations such as recipient resolution (top-level addressing, distribution group expansion, message bifurcation, etc.), routing resolution and content conversion. Mail flow rules are also applied in the categorizer. The SR agent 416 implements the SR policies (i.e., rules of the SR policies) as discussed above and ensures that messages that meet an SR policy are routed to the appropriate SR mailbox/folder, as described above.

After messages have been categorized, they are placed into a delivery queue 420 based on the destination of the message. Messages are queued by the destination mailbox, availability group, and so forth. The send service 422 routes messages to according to the destination. For example, the send service 422 can route messages to the mailbox transport delivery service for mailboxes that are on the same mailbox server or to the mailbox transport delivery service of a different mailbox server that is part of the same availability group. The send service 422 can route to the transport service of a mailbox server in a different availability group, or other grouping. For delivery through the internet, the send service 422 can route to the front end transport service, to the transport service on a different mailbox server, or various other ways depending on how the mailbox server is configured and connected to the internet.

### EXAMPLE MACHINE ARCHITECTURE AND MACHINE-READABLE MEDIUM

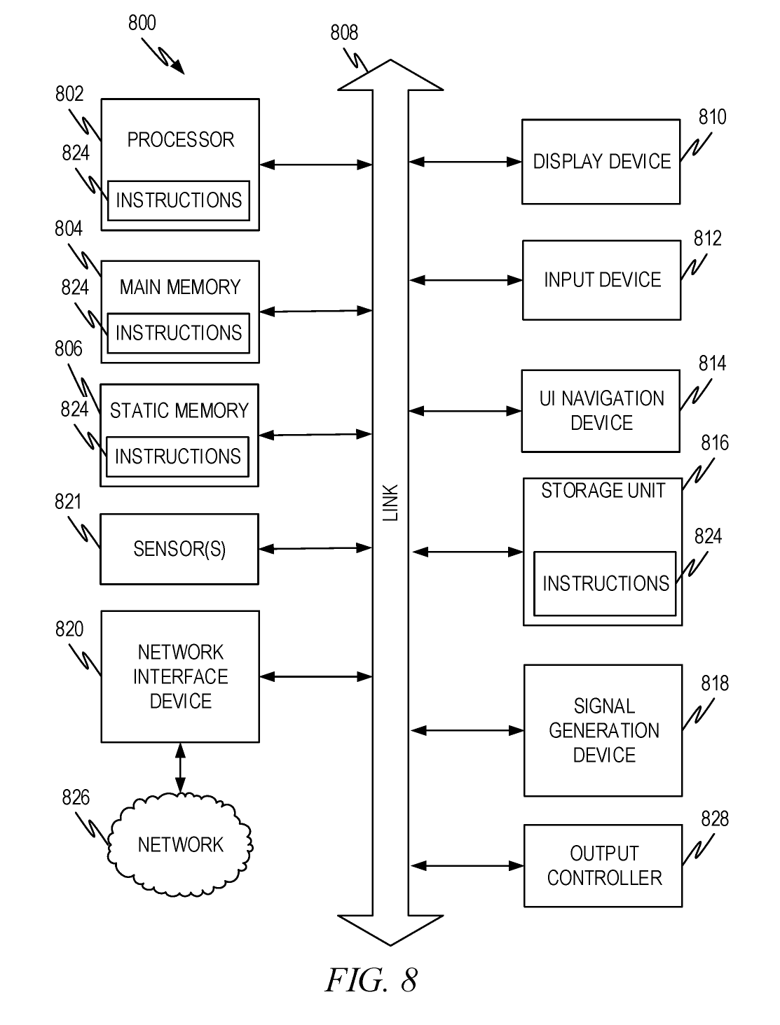

FIG. 8 illustrates a representative machine architecture suitable for implementing the systems and so forth or for executing the methods disclosed herein. The machine of FIG. 8 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 8 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 800 includes at least one processor 802 (e.g., a central processing unit (CPU), a graphics processing unit (GPU), advanced processing unit (APU), or combinations thereof), one or more memories such as a main memory 804, a static memory 806, or other types of memory, which communicate with each other via link 808. Link 808 may be a bus or other type of connection channel. The machine 800 may include further optional aspects such as a graphics display unit 810 comprising any type of display. The machine 800 may also include other optional aspects such as an alphanumeric input device 812 (e.g., a keyboard, touch screen, and so forth), a user interface (UI) navigation device 814 (e.g., a mouse, trackball, touch device, and so forth), a storage unit 816 (e.g., disk drive or other storage device(s)), a signal generation device 818 (e.g., a speaker), sensor(s) 821 (e.g., global positioning sensor, accelerometer(s), microphone(s), camera(s), and so forth), output controller 828 (e.g., wired or wireless connection to connect and/or communicate with one or more other devices such as a universal serial bus (USB), near field communication (NFC), infrared (IR), serial/parallel bus, etc.), and a network interface device 820 (e.g., wired and/or wireless) to connect to and/or communicate over one or more networks 826.

### EXECUTABLE INSTRUCTIONS AND MACHINE-READABLE MEDIUM

The various memories (i.e., 804, 806, and/or memory of the processor(s) 802) and/or storage unit 816 may store one or more sets of instructions and data structures (e.g., software) 824 embodying or utilized by any one or more of the methodologies or functions described herein. These instructions, when executed by processor(s) 802 cause various operations to implement the disclosed embodiments.

As used herein, the terms “machine-readable medium,” “computer-readable medium” and “device-readable medium” mean the same thing and may be used interchangeably in this disclosure. The terms include a single medium or multiple media (e.g., a centralized or distributed database, and/or associated caches and servers) that store the one or more instructions or data structures. The terms shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The terms shall accordingly be taken to include, but not be limited to, solid-state memories, and optical and magnetic media. Specific examples of machine-readable media, computer-readable media and/or device-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. The terms machine-readable media, computer-readable media, and device-readable media specifically exclude non-statutory signals per se, which are covered under the term “signal medium” discussed below.

### SIGNAL MEDIUM

The term “signal medium” shall be taken to include any form of modulated data signal and signals per se. The term “modulated data signal” means a signal that has one or more of its characteristics set or changed in such a matter as to encode information in the signal.

### EXAMPLE EMBODIMENTS

### Example 1

A method for supervisory review of electronic communications, comprising:

receiving a supervisory review policy, the policy comprising one or more rules, each rule comprising at least one of a condition, an action, and a property which together, the one or more rules selecting electronic communications for supervisory review;

monitoring electronic communications incoming to an electronic communication system to identify whether an electronic communication meets the supervisory review policy;

responsive to identifying that the electronic communication meets the supervisory review policy, delivering the electronic communication to a target mailbox and a supervisory review mailbox, both the target mailbox and supervisory review mailbox residing in the electronic communication system.

### Example 2

The method of example 1 further comprising:

presenting a user interface to a user having permissions to create the supervisory review policy;

receiving input via the user interface, the input identifying at least one of the condition, the action and the property;

creating the one or more rules based on the at least one of the condition, the action and the property;

storing the one or more rules; and

deploying the one or more rules via a policy sync service.

### Example 3

The method of example 1 wherein the electronic communication comprises at least one of:

an email;

a chat message from a chat server;

a social media comment;

a post;

a social media message; and

a voicemail.

### Example 4

The method of example 1 further comprising deploying an agent to an originating communication system.

### Example 5

The method of example 4 further comprising:

receiving, from the agent, a communication compatible with the electronic communication system, the communication comprising content extracted from an originating communication from the originating communication system and placed in the communication compatible with the electronic communication system.

### Example 6

The method of example 1 wherein the supervisory review mailbox is not accessible to the owner of the target mailbox.

### Example 7

The method of example 1 further comprising:

causing presentation of a user interface for the supervisory review mailbox, the user interface comprising controls that allow a user to mark each communication in the supervisory review mailbox as at least one of:

not reviewed;

compliant;

questionable;

non-compliant and under active investigation; and

non-compliant and resolved.

### Example 8

The method of example 1, 2, 3, 4, 5, 6, or 7, further comprising logging one or more supervisory review activities, each log entry comprising one or more of:

policy that selected a message for supervisory review;

unique identifier for the message;

message information or message metadata;

review status;

identity of a reviewer;

activity taken;

time and date of the action; and

combinations thereof.

### Example 9

The method of example 1, 2, 3, 4, 5, 6 or 7, further comprising presenting a user interface to an authorized user, the user interface comprising controls to allow the user to:

view a status of supervisory review policies;

download activity reports for further offline analysis;

select a policy and create a report for that policy;

create status activity reports;

create reviewer activity reports;

create reports based on logged data fields; and

enter time ranges or date ranges or both for a report.

### Example 10

A system for completing a question comprising:

a processor and executable instructions accessible on a computer storage medium that, when executed, cause the processor to perform operations comprising:

receive a supervisory review policy, the policy comprising one or more rules, each rule comprising at least one of a condition, an action, and a property which together, the one or more rules selecting electronic communications for supervisory review;

monitor electronic communications incoming to an electronic communication system to identify whether an electronic communication meets the supervisory review policy;

responsive to identifying that the electronic communication meets the supervisory review policy, delivering the electronic communication to a target mailbox and a supervisory review mailbox, both the target mailbox and supervisory review mailbox residing in the electronic communication system.

### Example 11

The system of example 10 wherein the operations further comprise:

present a user interface to a user having permissions to create the supervisory review policy;

receive input via the user interface, the input identifying at least one of the condition, the action and the property;

create the one or more rules based on the at least one of the condition, the action and the property;

store the one or more rules; and

deploy the one or more rules via a policy sync service.

### Example 12

The system of example 10 wherein the operations further comprise:

deploy an agent to an originating communication system.

### Example 13

The system of example 12 wherein the operations further comprise:

receive, from the agent, a communication compatible with the electronic communication system, the communication comprising content extracted from an originating communication from the originating communication system and placed in the communication compatible with the electronic communication system.

### Example 14

The system of example 10, 11, 12, or 13, wherein the operations further comprise:

cause presentation of a user interface for the supervisory review mailbox, the user interface comprising controls that allow a user to mark each communication in the supervisory review mailbox as at least one of:

not reviewed;

compliant;

questionable;

non-compliant and under active investigation; and

non-compliant and resolved.

### Example 15

The system of example 10 wherein the operations further comprise:

log one or more supervisory review activities, each log entry comprising one or more of:

policy that selected a message for supervisory review;

unique identifier for the message;

message information or message metadata;

review status;

identity of a reviewer;

activity taken;

time and date of the action; and

combinations thereof.

### Example 16

The system of example 10 wherein the operations further comprise:

present a user interface to an authorized user, the user interface comprising controls to allow the user to:

view a status of supervisory review policies;

download activity reports for further offline analysis;

select a policy and create a report for that policy;

create status activity reports;

create reviewer activity reports;

create reports based on logged data fields; and

enter time ranges or date ranges or both for a report.

### Example 17

A computer storage medium comprising executable instructions that, when executed by a processor of a machine, cause the machine to perform operations comprising:

receive a supervisory review policy, the policy comprising one or more rules, each rule comprising at least one of a condition, an action, and a property which together, the one or more rules selecting electronic communications for supervisory review;

monitor electronic communications incoming to an electronic communication system to identify whether an electronic communication meets the supervisory review policy;

responsive to identifying that the electronic communication meets the supervisory review policy, delivering the electronic communication to a target mailbox and a supervisory review mailbox, both the target mailbox and supervisory review mailbox residing in the electronic communication system.

### Example 18

The medium of example 17 wherein the operations further comprise:

deploy an agent to an originating communication system.

### Example 19

The medium of example 18 wherein the operations further comprise:

receive, from the agent, a communication compatible with the electronic communication system, the communication comprising content extracted from an originating communication from the originating communication system and placed in the communication compatible with the electronic communication system.

### Example 20

The medium of example 17, 18 or 19, wherein the operations further comprise:

cause presentation of a user interface for the supervisory review mailbox, the user interface comprising controls that allow a user to mark each communication in the supervisory review mailbox as at least one of:

not reviewed;

compliant;

questionable; and

non-compliant.

### Example 21

A method for supervisory review of electronic communications, comprising:

receiving a supervisory review policy, the policy comprising one or more rules, each rule comprising at least one of a condition, an action, and a property which together, the one or more rules selecting electronic communications for supervisory review;

monitoring electronic communications incoming to an electronic communication system to identify whether an electronic communication meets the supervisory review policy;

responsive to identifying that the electronic communication meets the supervisory review policy, delivering the electronic communication to a target mailbox and a supervisory review mailbox, both the target mailbox and supervisory review mailbox residing in the electronic communication system.

### Example 22

The method of example 21 further comprising:

presenting a user interface to a user having permissions to create the supervisory review policy;

receiving input via the user interface, the input identifying at least one of the condition, the action and the property;

creating the one or more rules based on the at least one of the condition, the action and the property;

storing the one or more rules; and

deploying the one or more rules via a policy sync service.

### Example 23

The method of example 21 or 22 wherein the electronic communication comprises at least one of:

an email;

a chat message from a chat server;

a social media comment;

a post;

a social media message; and

a voicemail.

### Example 24

The method of example 21, 22 or 23 further comprising deploying an agent to an originating communication system.

### Example 25

The method of example 24 further comprising:

receiving, from the agent, a communication compatible with the electronic communication system, the communication comprising content extracted from an originating communication from the originating communication system and placed in the communication compatible with the electronic communication system.

### Example 26

The method of example 25 wherein the communication compatible with the electronic communication system comprises an email communication.

### Example 27

The method of example 26 wherein the originating communicating communication comprises at least one of:

a chat message from a chat server;

a social media comment;

a post;

a social media message; and

a voicemail.

### Example 28

The method of example 25, 26, or 27, wherein the communication compatible with the electronic communication is received via a web service associated with the messaging system.

### Example 29

The method of example 21, 22, 23, 24, 25, 26, 27 or 28, wherein the supervisory review mailbox is not accessible to the owner of the target mailbox.

### Example 30

The method of example 21, 22, 23, 24, 25, 26, 27, 28 or 29, further comprising:

causing presentation of a user interface for the supervisory review mailbox, the user interface comprising controls that allow a user to mark each communication in the supervisory review mailbox as at least one of:

not reviewed;

compliant;

questionable;

non-compliant and under active investigation; and

non-compliant and resolved.

### Example 31

The method of example 21, 22, 23, 24, 25, 26, 27, 28, 29, or 30, further comprising logging one or more supervisory review activities, each log entry comprising one or more of:

policy that selected a message for supervisory review;

unique identifier for the message;

message information or message metadata;

review status;

identity of a reviewer;

activity taken;

time and date of the action; and

combinations thereof.

### Example 32

The method of example 21, 22, 23, 24, 25, 26, 27, 28, 29, 30 or 31, further comprising presenting a user interface to an authorized user, the user interface comprising controls to allow the user to:

view a status of supervisory review policies;

download activity reports for further offline analysis;

select a policy and create a report for that policy;

create status activity reports;

create reviewer activity reports;

create reports based on logged data fields; and

enter time ranges or date ranges or both for a report.

### Example 33

The method of example 22, 23, 24, 25, 26, 27, 28, 29, 30, 31 or 32, further comprising storing the supervisory review policy in a supervisory review policy database.

### Example 34

An apparatus comprising means to perform a method as in any preceding example.

### Example 35

Machine-readable storage including machine-readable instructions, when executed, to implement a method or realize an apparatus as in any preceding example.

### CONCLUSION

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

What is claimed is:

1. A method for supervisory review of electronic communications, comprising:
receiving a supervisory review policy, the policy comprising one or more rules, each rule comprising at least one of a condition, an action, and a property which together, the one or more rules selecting electronic communications for supervisory review;
monitoring electronic communications incoming to an electronic communication system to identify whether an electronic communication meets the supervisory review policy;
responsive to identifying that the electronic communication meets the supervisory review policy, delivering the electronic communication to a target mailbox and a supervisory review mailbox, both the target mailbox and supervisory review mailbox residing in the electronic communication system.

2. The method of claim 1 further comprising:
presenting a user interface to a user having permissions to create the supervisory review policy;
receiving input via the user interface, the input identifying at least one of the condition, the action and the property;
creating the one or more rules based on the at least one of the condition, the action and the property;
storing the one or more rules; and
deploying the one or more rules via a policy sync service.

3. The method of claim 1 wherein the electronic communication comprises at least one of:
an email;
a chat message from a chat server;
a social media comment;
a post;
a social media message; and
a voicemail.

4. The method of claim 1 further comprising deploying an agent to an originating communication system.

5. The method of claim 4 further comprising:
receiving, from the agent, a communication compatible with the electronic communication system, the communication comprising content extracted from an originating communication from the originating communication system and placed in the communication compatible with the electronic communication system.

6. The method of claim 1 wherein the supervisory review mailbox is not accessible to the owner of the target mailbox.

7. The method of claim 1 further comprising:
causing presentation of a user interface for the supervisory review mailbox, the user interface comprising controls that allow a user to mark each communication in the supervisory review mailbox as at least one of:
not reviewed;
compliant;
questionable;
non-compliant and under active investigation; and
non-compliant and resolved.

8. The method of claim 1 further comprising logging one or more supervisory review activities, each log entry comprising one or more of:
policy that selected a message for supervisory review;
unique identifier for the message;
message information or message metadata;
review status;
identity of a reviewer;
activity taken;
time and date of the action; and
combinations thereof.

9. The method of claim 1 further comprising presenting a user interface to an authorized user, the user interface comprising controls to allow the user to:
view a status of supervisory review policies;
download activity reports for further offline analysis;
select a policy and create a report for that policy;
create status activity reports;
create reviewer activity reports;
create reports based on logged data fields; and
enter time ranges or date ranges or both for a report.

10. A system for completing a question comprising:
a processor and executable instructions accessible on a computer storage medium that, when executed, cause the processor to perform operations comprising:
receive a supervisory review policy, the policy comprising one or more rules, each rule comprising at least one of a condition, an action, and a property which together, the one or more rules selecting electronic communications for supervisory review;
monitor electronic communications incoming to an electronic communication system to identify whether an electronic communication meets the supervisory review policy;
responsive to identifying that the electronic communication meets the supervisory review policy, delivering the electronic communication to a target mailbox and a supervisory review mailbox, both the target mailbox and supervisory review mailbox residing in the electronic communication system.

11. The system of claim 10 wherein the operations further comprise:
present a user interface to a user having permissions to create the supervisory review policy;
receive input via the user interface, the input identifying at least one of the condition, the action and the property;
create the one or more rules based on the at least one of the condition, the action and the property;
store the one or more rules; and
deploy the one or more rules via a policy sync service.

12. The system of claim 10 wherein the operations further comprise:
deploy an agent to an originating communication system.

13. The system of claim 12 wherein the operations further comprise:
receive, from the agent, a communication compatible with the electronic communication system, the communication comprising content extracted from an originating communication from the originating communication system and placed in the communication compatible with the electronic communication system.

14. The system of claim 10 wherein the operations further comprise:
cause presentation of a user interface for the supervisory review mailbox, the user interface comprising controls that allow a user to mark each communication in the supervisory review mailbox as at least one of:
not reviewed;
compliant;
questionable;
non-compliant and under active investigation; and
non-compliant and resolved.

15. The system of claim 10 wherein the operations further comprise:
log one or more supervisory review activities, each log entry comprising one or more of:
policy that selected a message for supervisory review;
unique identifier for the message;
message information or message metadata;
review status;
identity of a reviewer;
activity taken;
time and date of the action; and
combinations thereof.

16. The system of claim 10 wherein the operations further comprise:
present a user interface to an authorized user, the user interface comprising controls to allow the user to:
view a status of supervisory review policies;
download activity reports for further offline analysis;
select a policy and create a report for that policy;
create status activity reports;
create reviewer activity reports;
create reports based on logged data fields; and
enter time ranges or date ranges or both for a report.

17. A computer storage medium comprising executable instructions that, when executed by a processor of a machine, cause the machine to perform operations comprising:
receive a supervisory review policy, the policy comprising one or more rules, each rule comprising at least one of a condition, an action, and a property which together, the one or more rules selecting electronic communications for supervisory review;
monitor electronic communications incoming to an electronic communication system to identify whether an electronic communication meets the supervisory review policy;
responsive to identifying that the electronic communication meets the supervisory review policy, delivering the electronic communication to a target mailbox and a supervisory review mailbox, both the target mailbox and supervisory review mailbox residing in the electronic communication system.

18. The medium of claim 17 wherein the operations further comprise:
deploy an agent to an originating communication system.

19. The medium of claim 18 wherein the operations further comprise:
receive, from the agent, a communication compatible with the electronic communication system, the communication comprising content extracted from an originating communication from the originating communication system and placed in the communication compatible with the electronic communication system.

20. The medium of claim 17 wherein the operations further comprise:
cause presentation of a user interface for the supervisory review mailbox, the user interface comprising controls that allow a user to mark each communication in the supervisory review mailbox as at least one of:
not reviewed;
compliant;
questionable; and
non-compliant.
